(19) United States
(12) Patent Application Publication
(10) Pub. No.: US 2005/0247692 A1
(43) Pub. Date: Nov. 10, 2005

(54) Cordless soldering tool

(76) Inventors: Grigore Axinte, Kent, WA (US); Dragos Axinte, Bellevue, WA (US); John Lu, Renton, WA (US); Russell Borgmann, Bellevue, WA (US); Jeff Campbell, Bellevue, WA (US)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(21) Appl. No.: 11/138,887

(22) Filed: May 26, 2005

Related U.S. Application Data
(63) Continuation-in-part of application No. 10/656,900, filed on Sep. 5, 2003.
Application No. 10/656,900 is a continuation-in-part of application No. 10/016,937, filed on Dec. 14, 2001, now Pat. No. 6,646,228.
Application No. 10/016,937 is a continuation-in-part of application No. 09/726,546, filed on Aug. 18, 2000, now Pat. No. 6,797,924.
(60) Provisional application No. 60/149,416, filed on Aug. 18, 1999.
(60) Provisional application No. 60/618,945, filed on Oct. 13, 2004.
(60) Provisional application No. 60/626,505, filed on Nov. 8, 2004.

(51) Int. Cl. H05B 1/00; B23K 13/01

(52) U.S. Cl. 219/240; 219/229

(57) ABSTRACT

A portable electronic device, such as a soldering iron, is provided with two electrodes formed of or containing an electrically resistive material. The electrodes are electrically connected to a source of power. When both electrodes are applied to an electrically conductive material, such as the material to be soldered, an electrical circuit between the electrodes and an electrical power source is completed.

### CROSS-REFERENCES TO RELATED APPLICATIONS

This application is a continuation-in-part of pending U.S. patent application Ser. No. 10/656,900, filed Sep. 5, 2003, which is a continuation of U.S. patent application Ser. No. 10/016,937, filed Dec. 14, 2001 and issued as U.S. Pat. No. 6,646,228, which is a continuation-in-part of U.S. patent application Ser. No. 09/726,546, filed Aug. 18, 2000, and claims the benefit of U.S. Provisional Patent No. 60/149,416, filed Aug. 18, 1999. This application also claims the benefit of U.S. Provisional Patent Nos. 60/618,945, filed Oct. 13, 2004, and 60/626,505, filed Nov. 8, 2004. The disclosures of all related applications cited above are hereby incorporated by reference herein in their entirety.

### FIELD OF THE INVENTION

The present invention generally relates to electrical devices, and in particular, the present invention relates to portable electrical devices such as cordless soldering irons.

### BACKGROUND OF THE INVENTION

Soldering irons are often used when it is required to make manual electrical conductive connections between various electrical components. A wide variety of soldering irons have been developed for use in a variety of applications including the repair of printed circuit boards, and are used in many different industries, such as in the telecommunications industry, the computer industry, and the manufacturing industry. Known soldering irons vary by power source, application, performance, shape, size, temperature, tip type, heat source, price, and portability.

Various soldering irons exist today, including both corded and cordless soldering irons. One type of corded soldering iron uses a power cord to delivery AC power to the soldering iron from a common household outlet. In this corded soldering iron, a stepdown transformer is used to convert the power supplied to the soldering iron from AC to DC, for heating the electrode(s) at the soldering iron tip. One type of cordless soldering iron is the butane soldering iron. The butane iron includes the use of a highly flammable gas that is used to heat a tip of the soldering iron.

### SUMMARY OF THE INVENTION

It is an object of the present invention to provide a soldering tool comprising a portable electrical power storage source, wherein said electrical power storage source has a low power condition. A heating device is electrically connected to the electrical power storage source for providing soldering connections. A voltage comparator is electrically connected to the electrical power storage source and the heating device, the voltage comparator capable of detecting the low power condition of the electrical power storage source.

A further object of the invention is to provide an electronic apparatus having a body and an electrical power storage source associated with said body. The electrical power storage source includes positive and negative terminals, wherein the electrical power storage source has a normal power condition and a low power condition. A heating device is further associated with the body, wherein a first portion of the heating device is connected to the positive terminal and a second portion of the heating device is connected to the negative terminal so that electricity may be transmitted to the heating device. A status indicator is electrically connected to the electrical power storage source and the heating device. The status indicator is capable of generating a signal indicative of a low power condition of the electrical power storage source.

It is yet another object of the invention to provide a soldering iron adapted to receive electricity from a power source. A tip is electrically connectable to the power source, operable to generate heat upon application of electricity. A switch is electrically connected between the tip and the power source, having at least first and second positions that cause a first power output to be generated by the tip when the switch is in the first position. The higher power output is generated by the tip when the switch is in the second position.

Another object of the invention is to provide an electronic apparatus including an electrical power source having at least one low power condition. A heating device is electrically connected to the electrical power source. The electronic apparatus also includes means for detecting at least one low power condition of the electrical power source, and means for indicating the at least one power condition.

In yet another embodiment, an electronic apparatus is provided that is powered by an electrical power source. The electronic apparatus includes a heating device that receives electricity from the electrical power source, and means for detecting at least one low power condition of the electrical power source when the heating device receives electricity from the electrical power source.

According to another embodiments, the invention provides a soldering iron having an electrical power storage source with a low power condition. The soldering iron also has a tip electrically connected to the power source, where the tip is operable to generate heat upon application of electricity. A voltage comparator is electrically connected to the electrical power storage source and the tip, where the voltage comparator is capable of detecting the low power condition of the electrical power storage source.

In yet another embodiment, the invention provides a soldering iron having an electrical power storage source developing direct current (DC) and having a low power condition. A tip is electrically connected to the power source, where the tip includes first and second electrodes that are operable to generate heat upon application of electricity. A voltage comparator is electrically connected to the electrical power storage source and the tip, where the voltage comparator is capable of detecting a low power condition. A status indicator generates a signal to a user in response to the voltage comparator detecting a low power condition.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an elevation view of one exemplary embodiment of a soldering iron formed in accordance with the present invention;

FIG. 2 is a front elevation view of one exemplary embodiment of a soldering tip formed in accordance with the present invention;

FIG. 3 is an exemplary embodiment of a circuit suitable for use with an exemplary embodiment of the soldering iron illustrated in FIG. 1;

FIG. 4A is another exemplary embodiment of a circuit suitable for use with an exemplary embodiment of the soldering iron illustrated in FIG. 1;

FIG. 4B is another exemplary embodiment of a circuit suitable for use with an exemplary embodiment of the soldering iron illustrated in FIG. 1;

FIG. 5 is an exemplary embodiment of a circuit, electrically connectable to the circuit diagrams illustrated in FIGS. 3 and 4, suitable for use with the exemplary embodiment of the soldering iron illustrated in FIG. 1;

FIG. 6A is another exemplary embodiment of a circuit suitable for use with an exemplary embodiment of the soldering iron illustrated in FIG. 1;

FIG. 6B is another exemplary embodiment of a circuit suitable for use with an exemplary embodiment of the soldering iron illustrated in FIG. 1;

FIG. 7 is an elevation view of another exemplary embodiment of a soldering iron formed in accordance with the present invention;

FIG. 8 is an elevation view of one exemplary embodiment of a tip assembly that is suitable for use with the soldering iron of FIG. 7;

FIG. 9 is an elevation view of another exemplary embodiment of a tip assembly that is suitable for use with the soldering iron of FIG. 7;

FIG. 10 is a cross section view of the tip assembly taken along cross sectional lines 10-10 in FIG. 9;

FIG. 11 is an elevation view of another exemplary embodiment of a tip assembly that is suitable for use with the soldering iron of FIG. 7;

FIG. 12 is an elevation view of another exemplary embodiment of a tip assembly that is suitable for use with the soldering iron of FIG. 7;

FIG. 13 is a partial cross sectional view of another exemplary embodiment of a tip assembly that is suitable for use with the soldering iron of FIG. 7;

FIG. 14 is an exemplary embodiment of a circuit suitable for use with an exemplary embodiment of the soldering iron illustrated in FIG. 7;

FIG. 15 is another exemplary embodiment of a circuit that is suitable for use with an exemplary embodiment of the soldering iron illustrated in FIG. 7;

FIG. 16A is another exemplary embodiment of a circuit suitable for use with an exemplary embodiment of the soldering iron illustrated in FIG. 7;

FIG. 16B is another exemplary embodiment of a circuit suitable for use with an exemplary embodiment of the soldering iron illustrated in FIG. 7;

FIG. 17 is an exemplary embodiment of a circuit, electrically connectable to the circuits illustrated, for example, in FIGS. 14 and 15, suitable for use with the exemplary embodiment of the soldering iron illustrated in FIG. 7;

FIG. 18 is another exemplary embodiment of a circuit suitable for use with an exemplary embodiment of the soldering iron illustrated in FIG. 7;

FIG. 19 is a block diagram of one suitable system constructed in accordance with aspects of the present invention that use be suitable for use with the soldering irons illustrated in FIGS. 1 and 7; and

FIG. 20 is another embodiment of a circuit that may be suitable for use with the soldering iron illustrated in FIG. 7.

### DETAILED DESCRIPTION OF THE PREFERRED EMBODIMENTS

The present invention will now be described with reference to the drawings where like numerals correspond to like elements. Embodiments of the present invention are directed to soldering tools that include circuitry for providing multiple power modes, and for detecting low power conditions or a drop in voltage of the power source during the operation of the device. In embodiments of the present invention, the circuitry detects either a voltage drop across a power source or a low power condition and signals the operator. Accordingly, the following descriptions and illustrations herein should be considered illustrative in nature, and thus, not limiting the scope of the present invention, as claimed.

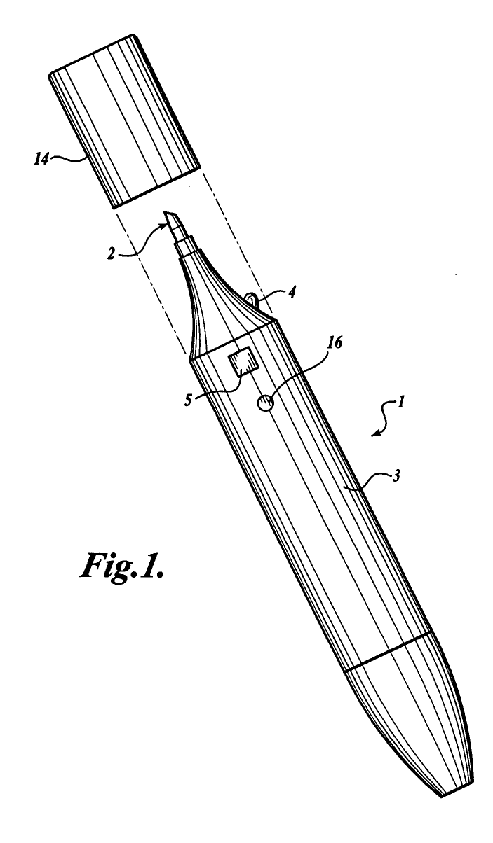

Referring to FIG. 1, one exemplary embodiment of a cordless soldering iron 1 formed in accordance with the present invention is illustrated. The soldering iron 1 includes a tip 2 attached to a body 3. The soldering iron 1 further includes an electric light 4 disposed on the body 3 in order to illuminate the tip 2 and any surrounding work surfaces that may be in the vicinity of the soldering iron 1. A switch 5 that is disposed on the body 3 controls the operation of the electric light 4. As is further illustrated in FIG. 1, the soldering iron 1 may also includes a cap 14 for covering the tip 2 and the electric light 4. As will be described in detail below, the soldering iron 1 may include a switch 5A that selects one of a number of power levels to be generated at tip 2, and provides a “stand-by” mode that enables the tip 2 to complete an electrical circuit upon contact with solder material or a workpiece.

As can be seen from FIG. 1, the body 3 includes an elongated, substantially tubular member constructed of a rigid heat-resistant material, such as plastic or other materials known to those of ordinary skill in the art. The body 3 is generally a unitary structure, assembled in parts, and figured to hold the sub-components and circuitry described herein. Those of ordinary skill in the art recognize that the configuration of the body 3 may vary widely depending upon the different needs related to various applications and industries.

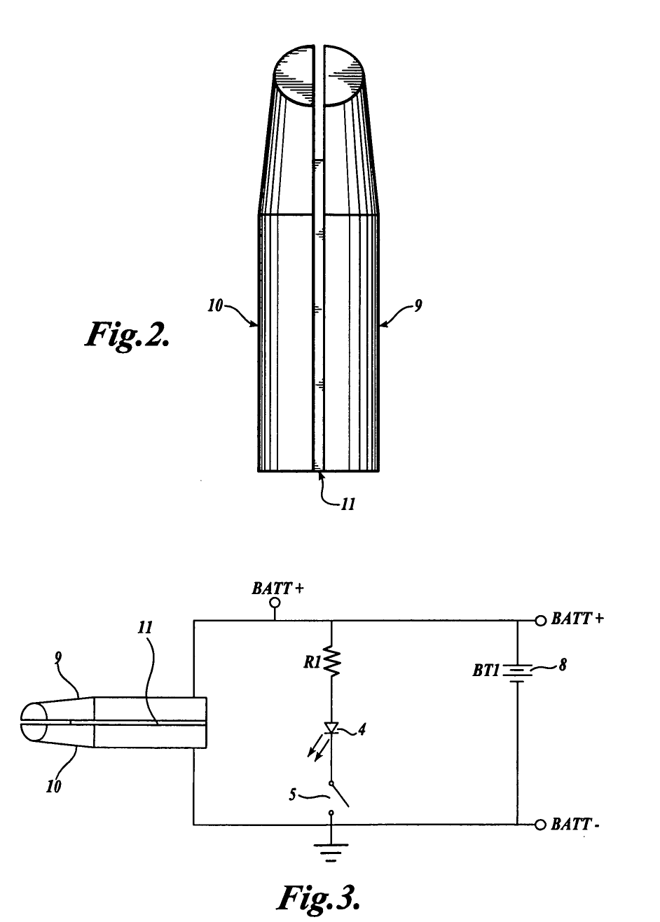

FIG. 2 is a front elevational view of one exemplary embodiment of the soldering tip 2 formed in accordance with an exemplary embodiment of the present invention. As illustrated, the tip 2 includes two electrodes 9 and 10, which are electrically isolated from one another by an insulator 11 disposed there between. The insulator 11 may be formed of any suitable material that performs as a dielectric. The insulator 11 is preferably formed of a solid dielectric material, such as Mica, that is able to withstand temperatures in excess of about 500° F. without changing state. The size and shape of the tip 2 may vary depending upon the soldering application required by a particular application and/or industry.

The electrodes 9 and 10 are preferably formed of a semi-conductive material, such as germanium, graphite, or silicon, or a material containing a semi-conductive material, such as germanium, graphite, or silicon. The electrodes are preferably made of graphite. In another embodiment, the electrodes 9 and 10 may be constructed from or include a resistive alloy, preferably NiCr (e.g., NiCr A and NiCr C obtain suitable results with the power sources contemplated with the present invention).

In several embodiments of the present invention, the electrical resistivity of the electrodes 9 and 10 is approximately 250 micro-Ohm cm or greater, preferably approximately 750 micro-Ohm cm or greater, and more preferably approximately 1,500 micro-Ohm cm or greater. In other embodiments, the electrical resistivity of the electrodes 9 and 10 is greater than approximately 3,000 micro-Ohm cm. In several embodiments, the electrodes 9 and 10 preferably have a density in the range of approximately 1.0 to 2.2 g/cc, and preferably between 1.5 and 1.75 g/cc, and preferably, a flexural strength of at least 1,500 psi. Due to the preferable property values of the electrodes, the electrodes 9 and 10 reaches a temperature greater than 500° F. within a few seconds upon the application of electricity, and remains a solid at temperatures in excess of about 1,000° F. It will be appreciated that embodiments of the present invention may include any combination of the aforementioned property values.

The tip 2 is generally attached to the body 3 of the soldering iron 1, preferably in a detachable manner. Making the tip 2 detachable in several embodiments permits a user of the soldering iron 1 the option of replacing the tip 2 if it becomes damaged or otherwise unusable. Moreover, because of the detachable nature of the tip 2, the user of the soldering iron 1 may use various tips when different soldering applications require such versatility.

FIG. 3 illustrates one exemplary circuit suitable for use with the exemplary embodiment illustrated in FIG. 1. When the tip 2 is secured to the soldering iron 1, the electrodes 9 and 10 are separately electrically connected to the positive and negative terminals of an electrical power source 8. In one embodiment, metallic contacts (not shown), preferably of beryllium copper alloy, are utilized to supply power to the electrodes 9 and 10. The contacts are coupled to the body 3 and electrically connect to the remaining components of the circuit shown in FIG. 3. When assembled, the electrodes 9 and 10 contact the spaced contacts in a manner that provides electrical intercommunication. The contacts are preferably bent to function as a spring to minimize contact resistance. In the case of the circuit illustrated in FIG. 3, the electrical power source 8 is a battery (BT1). However, a variety of electrical power source 8 can be used, including rechargeable or non-rechargeable batteries or battery cells, or a low-voltage power source provided via a power providing device. In one embodiment of the electrical power source 8, illustrated in FIG. 3, the battery BT1 provides a nominal voltage of greater than 2.4 volts and an amperage of at least 700-750 milliamps.

Other embodiments may use power sources 8 having voltages in the range of five (5) to (10) volts, while others may use power sources 8 having voltages greater than 10 volts. Additionally, the power sources 8 utilized by embodiments of the present invention preferably have an instantaneous power of between 8-40 watts and an amperage of greater than 700 milliamps. In one exemplary embodiment of the present invention, the power source 8 is constructed of five (5) non-rechargeable batteries each having a voltage of approximately 1.5 volts. The batteries of the power source are connected in a conventional manner to provide a power source with approximately 7.5 volts. In embodiments of the present invention when batteries are utilized as the power source, the battery contacts are preferably of the leaf spring type for increased surface area contact and applied compression force against the batteries in an in-line arrangement to minimize losses.

When the ends of the electrodes 9 and 10 are applied to an electrically conductive or semi-conductive material, such as solder or a workpiece, an electrical circuit is completed from the positive terminal of the electrical power source 8, through the electrode 9, further through the electrically conductive or semi-conductive material to which the tip 2 has been applied, and even further through the electrode 10 and completed back to the negative terminal of the electrical power source 8. In completing the circuit by way of the electrodes 9 and 10 and the electrically conductive or semi-conducted material used in conjunction with electrodes 9 and 10, a flow of electricity from the electrical power source 8 causes the tip 2 to heat to a temperature greater than about 500° F., within a few seconds. As a result of the materials used in conjunction with the electrodes 9 and 10, the tip 2 does not become soldered to the joint while being used to create a solder connection. Once the electrodes 9 and 10 are removed from or are taken away from contact with the electrically conductive or semi-conductive material, the circuit to the electrical power source 8 is no longer complete, and therefore, the soldering iron is put into a non-heating state. In this state, the electrodes 9 and 10 cool to a safe temperature.

As is further illustrated in FIG. 3, the circuit includes the switch 5 along with the electric light 4 (e.g., a light-emitting diode) and a resistor R1. The light 4 is positioned on the body of the soldering iron to thereby illuminate the tip 2 and any surrounding work area. Because of the parallel placement of the resistor R1, the light 4 and the switch 5, the light 4 may be operated separately or in conjunction with the tip 2. That is, closing the switch 5 will create an electrical connection between the negative and positive terminals of the power source 8, even if the electrodes 9 and 10 are not currently being used in conjunction with electrically conductive or semi-conductive material. In other words, the circuit portion with the light 4 is independent from the circuit portion created in conjunction with the electrodes 9 and 10. Because the electric light 4 may be switched on without heating the tip 2, the light 4 may be used to illuminate surroundings without having to unnecessarily heat the tip 2. In one embodiment, the value of the resistor R1 is preferably 150 Ω.

It will be appreciated that another switch, not shown, may be placed in series with the power source to function as an on/off switch for the soldering iron, where, when the soldering iron is “on,” it operates in a stand-by mode until such time when the electrodes 9 and 10 maintain simultaneous contact with solder material or a workpiece. Alternatively, it will be appreciated that the switch 5 may be placed in series with the power source to form this switching capability. In this latter embodiment, the light will function by activation of the on/off switch.

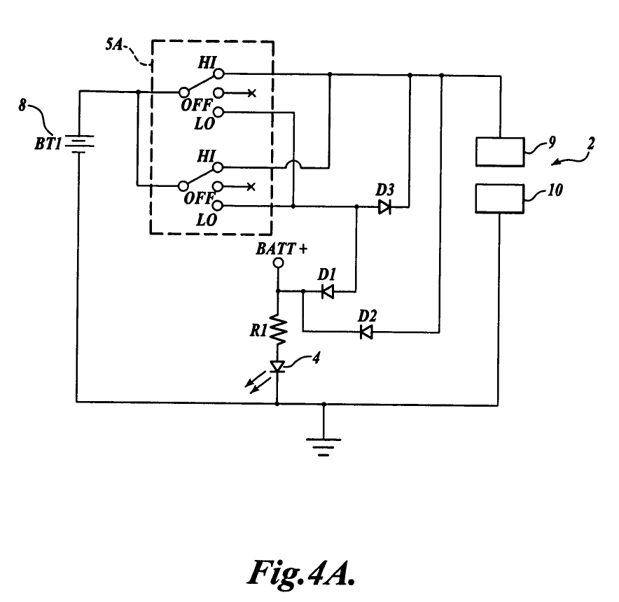

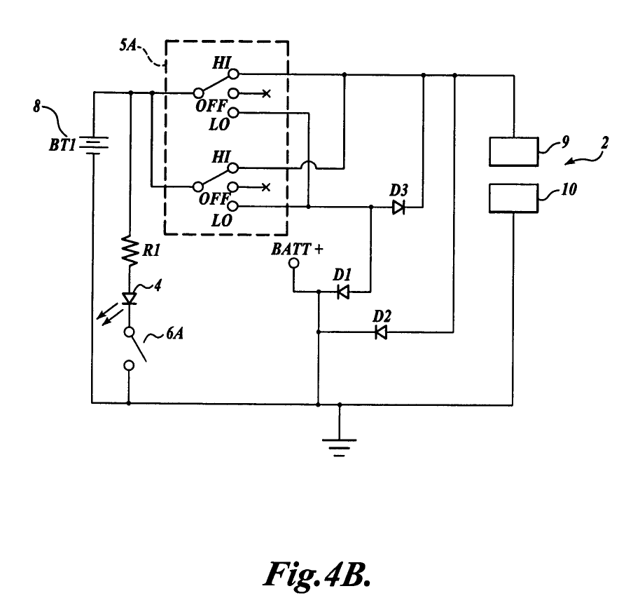

FIG. 4A illustrates another exemplary circuit that is suitable for use with an exemplary embodiment of the soldering iron illustrated in FIG. 1. When the tip 2 is secured to the soldering iron 1, the electrodes 9 and 10 are separately electrically connected to the positive and negative terminals of an electrical power source 8 via components that will be described below. In the case of the circuit illustrated in FIG. 4A, the electrical power source 8 is a battery (BT1). However, a variety of different electrical power sources can be used, including rechargeable or non-rechargeable batteries or battery cells, or a low-voltage power source provided via a power providing device.

As is further illustrated in FIG. 4A, the circuit includes a switch 5A along with the electric light 4 (e.g., a light-emitting diode), a number of diodes D1 and D2, and a resistor R1. As was described above, the light 4 is positioned on the body of the soldering iron to thereby illuminate the tip 2 and any surrounding work area. Because of the serial placement of the switch 5A with respect to the power source 8, the light 4 is operated in conjunction with the tip 2. Additionally, because of the serial placement of the switch 5A between the power source 8 and the electrodes 9 and 10 in this embodiment, for the electrodes 9 and 10 to receive power, the switch 5A is required to be in the closed or activated state (e.g., the switch is either in the “Hi” or “Lo” position) to be in the stand-by mode for enabling soldering connections by the electrodes. The switch 5A may be a double-pole/triple-throw switch as shown.

In other embodiments, as shown in FIG. 4B, the light 4 may be placed in parallel with the power source 8 and in series with another switch 6A for selectively operating the light 4, if desired.

The switch 5A allows the user to select the power output of the soldering iron 1 between a number of power outputs, such as a high output and a low output, and an off position. To affect the different power modes controlled by the switch 5A, the circuit includes a diode D3 in the circuit path between the “Lo” nodes of the switch 5A and the electrode 9 for reducing the overall power generated by the tip electrodes 9 and 10 when the switch 5A is disposed in the “Lo” position. As a result, the power output generated by the tip 2 when the switch 5A is in the “Lo” position is less than the power output generated by the tip 2 when the switch 5A is in the “Hi” position. In one embodiment, the power output difference between the high and low power output positions is approximately ten (10) watts, although other power output differences may be practiced with the present invention. It will be appreciated that a diode has been selected so that heat generation may be kept to a minimum. However, other circuitry or components that cause a reduction in current supplied to the tip 2, such as a resistor, may be used.

In accordance with an aspect of the present invention, the soldering iron 1 may also include low voltage detection circuit. The circuit may be optionally used with the circuits illustrated in FIGS. 3 and 4. The circuitry when used in conjunction with the circuits of FIG. 3 or FIG. 4 can be utilized to detect a low power condition, an operational voltage drop by the electrical power source 8, or current flowing across the electrodes 9 and 10 (i.e. short state across the electrodes).

Generally described, the circuit functions to indicate by way of a light, disposed on the soldering iron 1, a low power condition of the electrical power source 8, an operational drop in voltage, or a short across the electrodes 9 and 10. This is accomplished by comparing the voltage produced by the electrical power source 8 (across the source 8) during use, hereinafter referred to as the operational voltage, with a preselected reference voltage. The reference voltage, if the power source is a battery, may be selected between the voltage of a fully charged battery and the voltage of a partially or fully discharged battery. If the operational voltage of the electrical power source drops below the reference voltage at any time during use, then the circuit is configured to illuminate the light. It will be appreciated that when the power source 8 is a battery, the operational voltage varies upon usage of the device.

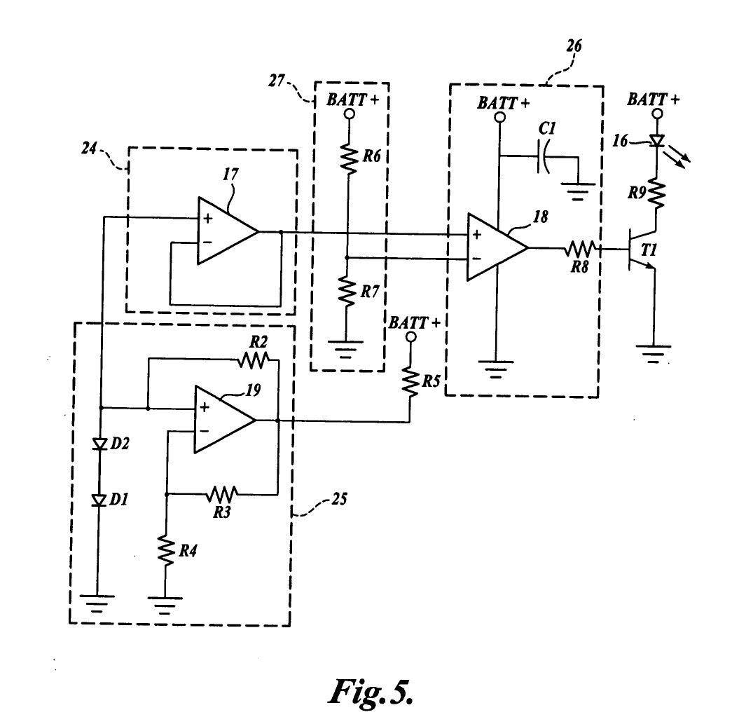

One suitable embodiment of a low voltage detection circuit that may be practiced with the present invention is illustrated in FIG. 5. Connection to the circuit illustrated in FIG. 5 may be accomplished by way of connection points BATT+illustrated in both FIGS. 3 and 4. As shown in FIG. 5, the low voltage detection circuit includes a voltage follow or buffer 24, a reference voltage generator 25, and a voltage comparator 26. In one embodiment, the voltage follower or buffer 24 may be configured as an operational amplifier 17. In one embodiment, the reference voltage generator 25 may be formed by an operational amplifier 19, in conjunction with resistors R2, R3, R4, and diodes D1 and D2, which provides the reference voltage discussed above. A resistor R5 further operates in conjunction with the operational amplifier 19. The resistor R2 is preferably 39 kΩ, the resistor R3 is preferably 150 kΩ, the resistor R4 is preferably 47 kΩ, and the resistor R5 is preferably 2.7MΩ.

The reference voltage generated by the reference voltage generator 25 and supplied to the voltage follower or buffer 24, is further supplied to the voltage comparator 26. A voltage divider 27, which receives electricity from BATT+, supplies the voltage comparator 26 with the operational voltage of the power source 8. For example, if the circuit shown in FIG. 3 is used, the voltage divider 27 may continuously supply the voltage comparator 26 with the operational voltage of the power source 8. It will be appreciated that if the circuit shown in FIG. 4 is used, the voltage divider 27 supplies the voltage comparator 26 with the operational voltage of the power source 8 when the switch 5A is activated. In the embodiment shown, the voltage divider 27 is comprised of a resistor R6 and a resistor R7, and the voltage comparator 26 is formed by an operational amplifier 18 and associated circuitry, including a capacitor C1 and a resistor R8. In the embodiment shown, the output of the voltage buffer 24 is supplied to the non-inverting input of the operational amplifier 18 and the output of the voltage divider 27 is supplied to the inverting input of the operational amplifier 18. The resistor R6 is preferably 200 kΩ, while the resistor R7 is preferably 47 kΩ. The capacitor C1 is preferably 0.1 UF and the resistor R8 is preferably 1 kΩ.

Finally, the circuit illustrated in FIG. 5 includes a transistor T1 in electrical contact with the electric light 16 and a resistor R9. The value of the resistor R9 used in conjunction with the electric light 16 and the transistor T1 is preferably 100 Ω.

During use (e.g., when the switch 5A is activated if utilizing the circuit of FIG. 4), if the voltage of the electrical power source 8 drops below a preselected threshold, i.e., reference voltage, the transistor T1 is turned on which allows illumination of the electric light 16. This may occur when a short exists across the electrodes 9 and 10, or when the power source 8 is in a low power condition. For example, a drop in voltage may occur when testing a soldered joint with the electrodes 9 and 10 in order to determine a short state of a circuit, for example, on a circuit board, or when a workpiece is disposed in electrical communication between the electrodes 9 and 10. A low power condition may occur when the power source, such as the battery BT1, is either substantially or partially discharged, depending on the reference voltage selected for each particular application.

Stated differently, when the circuitry of FIG. 5 detects a load on the electrical power source 8 as indicated by current flowing across the electrodes 9 and 10 (short circuit across the electrodes 9 and 10), or the power source 8 is discharged below the reference voltage, the electric light 16 is illuminated. This occurs since the result of the voltage comparator 26 upon comparing the reference voltage from the reference voltage generator 25 with the operational voltage from the voltage divider 27 causes the transistor T1 to turn on, thereby allowing the supply of current to flow through the light 16. It will be appreciated that the circuitry herein described may be useful in assisting the operator to indicate when solder is placed in-between the electrodes 9 and 10, when a workpiece creates a short across the electrodes, or to test if a short exists across two nodes of a circuit. Additionally, it will be appreciated that the circuit may be useful in alerting the user when the power source needs to be replaced or recharged. In an alternative embodiment, the soldering iron 1 may be implemented with a tone-producing mechanism (not shown) that creates an auditory response when a low power condition or voltage drop is detected.

It may be advantageous during operation of the soldering iron to completely isolate or shut off power from the electrical power source, such as a battery, when a low power condition is detected so that the battery cannot discharge past a desired level.

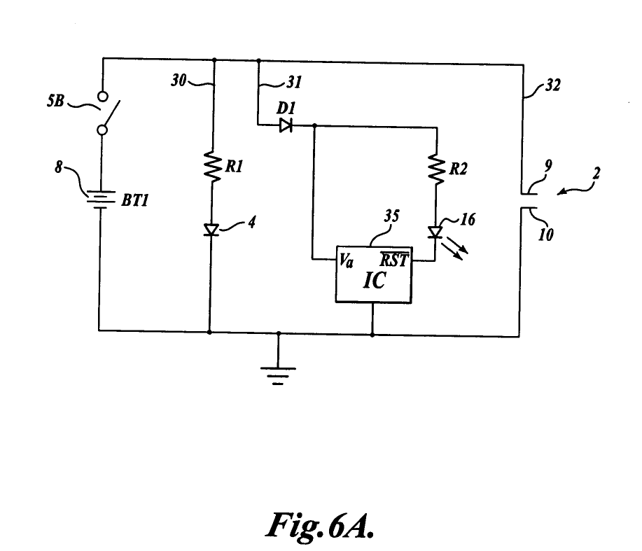

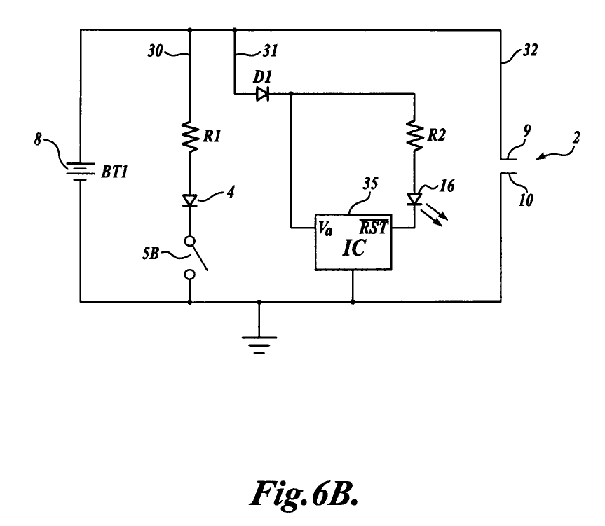

FIG. 6A is an alternative embodiment of a low power detection circuit suitable for use with an exemplary embodiment of the soldering iron 1 for detecting a low power condition, an operational voltage drop by the electrical power source 8, or current flowing across the electrodes 9 and 10. As best shown in FIG. 6A, the circuit includes a switch 5B connected in series with the power source 8 and a number of circuit paths 30, 31, and 32. As shown, the circuit paths are connected in parallel with the power source 8. Circuit path 30 comprises a resistor R1 and the light 4, e.g., light emitting diode (LED), circuit path 31 includes an integrated circuit (IC) 35, a diode D1, a resistor R2, and the electric light 16, e.g., light emitting diode (LED), and circuit path 32 includes the electrodes 9 and 10. Accordingly, the switch 5B controls the activation of the light 4, the integrated circuit 35, and the electrodes 9 and 10. Alternatively, as best shown in FIG. 6B, the switch 5B may be placed along circuit path 30 in series with the light 4. In this embodiment, the switch 5B only controls the illumination of the light 4, and may be operated independent from the soldering iron tip 2 and/or the integrated circuit 35.

In another embodiment, two switches may be used, one being placed in series with the power source, which acts as an on/off switch, and one placed in series with the light, which selectively controls the operation of the light when working in conjunction with the on/off switch.

The integrated circuit 35 is capable of internally generating a reference voltage, comparing the reference voltage to the operational voltage of the power source 8, and based on the comparison, activating a switch that permits the light 16 to illuminate. The integrated circuit utilized in one embodiment is commercially available from Texas Instruments, as model No. TL7757. The integrated circuit 35 is connected in parallel with the power source 8 and the electrodes 9 and 10. In one embodiment, the value of R2 is 100 ohms. It will be appreciated that the integrated circuit may be specifically selected based on the reference voltage it generates. Therefore, depending upon its application, the circuit of FIGS. 6A and 6B may use other integrated circuits that function substantially similar to integrated circuit 35 but with a different reference voltage.

During use, the operational voltage from the power source 8 is supplied to integrated circuit 35. In FIG. 6A, this occurs when the switch 5B is activated. In FIG. 6B, electricity is continuously supplied to the integrated circuit 35. In either case, this may occur regardless of whether a short exists across the electrodes 9 and 10. The integrated circuit 35, which includes components that generate a reference voltage, compares the operational voltage supplied to the integrated circuit 35 with the reference voltage generated by the integrated circuit 35. If the reference voltage is greater than the operational voltage, the integrated circuit 35 activates a switch, delivering current that flows through the light 16, and as a result, illuminates the light 16.

For example, when a short occurs across the electrodes 9 and 10, the load on the power source 8 by the resistivity of the electrodes 9 and 10 and the electrical conductor, e.g. workpiece that causes the short condition, causes the voltage of the power source 8 to drop. It will be appreciated that the reference voltage may be selected such that if a short occurs across the electrodes 9 and 10, the operational voltage measured by the integrated circuit 35 will be lower than the reference voltage. As a result, the light 16 will illuminate, thereby giving the user a visible indication that a short across the electrodes 9 and 10 has occurred.

Additionally, it will be appreciated that in one embodiment, the reference voltage may be selected so that a low power condition of the power source (e.g., a battery that is substantially discharged) will cause the light 16 to illuminate. Thus, in accordance with another aspect of the present invention, the light may be utilized to indicate when the power source is in need of replacement or a recharge.

It will be appreciated that other status indicators other than the light 16 may be utilized by the soldering iron 1. For example, a tone-producing mechanism (not shown) that creates an auditory response when a low power condition or a voltage drop is detected may be implemented with the soldering iron 1.

On the other hand, if the reference voltage is less than the operational voltage, the switch of the integrated circuit 35 remains open, and the light 16 does not illuminate. This may occur when a short does not exist across the electrodes 9 and 10 and the power source 8 has a sufficient charge.

As will be appreciated by those of ordinary skill in the art, the circuitry illustrated in FIGS. 3-6B may be embodied in an integrated circuit, or other known electrical device used to provide prefabricated circuitry to devices produced for a generally large consumer market. Moreover, it is generally feasible that one or more parts of the circuitry illustrated in FIGS. 3-6B may be embodied in an integrated circuit, and other parts of the circuitry may produced with electrical components which is not specifically integrated with the integrated circuit.

It will be appreciated that the term “low power condition” my also refer to the condition when a short occurs across the electrodes (e.g., when a load is placed upon the power source), causing the power source to drop in voltage, thereby attaining a low voltage condition.

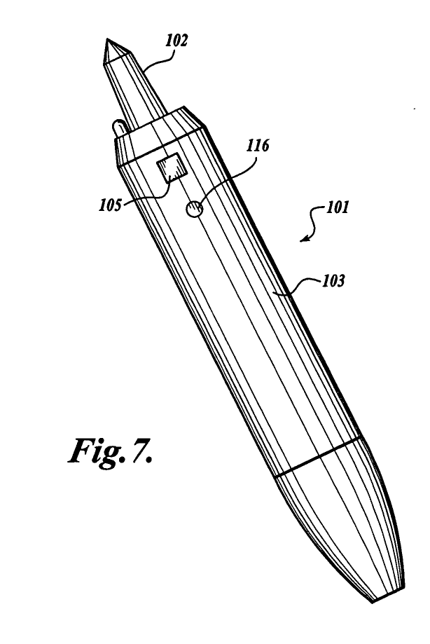

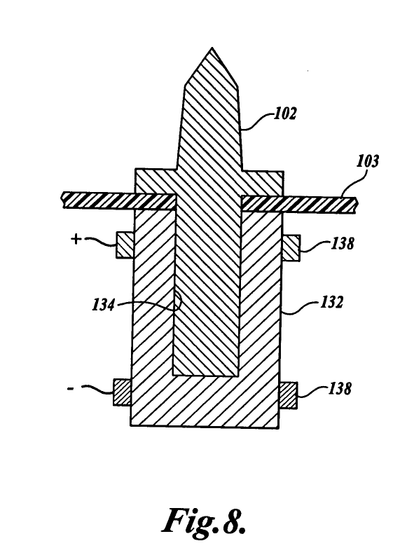

While the preceding embodiments have been illustrated herein and described above as being of a split tip design, i.e., having a tip comprised of first and second electrically isolated electrodes, soldering irons of the present invention may be of the single electrode type. To that end, attention is directed to FIGS. 7 and 8, which illustrate another embodiment of an electrical device, namely, a soldering iron 101 formed in accordance with the present invention. The soldering iron 110 is substantially similar in construction, materials, and operation as the soldering iron illustrated in FIGS. 1-6B, except for the differences that will now be described. As best shown in FIG. 7, the soldering iron 101 comprises a soldering iron tip 102 connected to a soldering iron body 103.

As best shown in FIG. 8, the soldering iron 101 further includes a heating device 132 for heating the soldering iron tip 102 to an appropriate temperature to effect soldering of, for example, a workpiece. In one embodiment, the heating device 132 defines a bore 134 into which the proximal end of the soldering iron tip 102 is inserted. The interface between the heating device 132 and the soldering iron tip 102 is preferably of an interference fit for good heat transfer there between. In this embodiment, metallic clamps 138 may be used to route electricity through the heating device 132, or the heating device may be constructed with electrical terminals for electrical connection to the power source. A heat insulating body (not shown) that encases the heating device 132 may further be provided, if desired. The heat insulating body may be constructed of any suitable material, such as heat resistant plastics or ceramics.

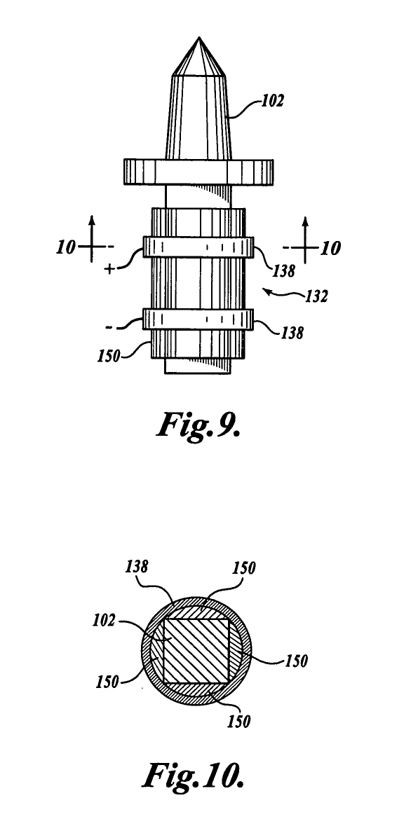

In an alternative embodiment shown in FIGS. 9 and 10, the heating device 132 includes one or more heating elements 150 disposed in heat transfer relationship with the soldering iron tip 102. The heating elements are preferably secured to or maintained adjacent the tip 102 by either mechanical techniques, i.e., brackets, clamps, screws, etc. or chemical techniques, i.e., epoxy, adhesives, to maintain a positive connection there between. In the embodiment shown, the heating elements 150 are held in place via clamps 138 constructed of a metallic material, such as copper. However, other arrangements may be used. For example, the soldering iron body 103 may be specifically designed with flanges, tabs, or other interior structure that retains the heating elements 150 in contact with the soldering iron tip 102 once assembled. The clamps 138 may also be used as power source connection terminals for connecting the heating elements 150 in electrical communication with a power source 108.

The heating device 132 and heating elements 150 shown in FIGS. 8-10 may be electrically isolated from the soldering iron tip 102. In several embodiments, this may be accomplished by disposing an electrical isolation barrier (not shown), such as a dielectric layer, between the heating device or elements and the tip 102. The electrical isolation barrier may be formed by a polyimide substrate, preferably chemically secured via adhesive or the like to one of the surfaces. One such dielectric polyimide substrate that may be practiced with the present invention is sold as Kapton® tape, commercially available from DuPont®. In another embodiment, the outer surface of the heating device or elements or the soldering iron tip 102 may be coated with a thin dielectric film, such as a Phenolic coating. In yet another embodiment, the soldering iron tip 102 may be constructed from anodized aluminum, the anodized surface of the tip 102 performing as a dielectric between the soldering iron tip and the heating device or elements. It will be appreciated that the thickness of the electrical isolation barrier should be kept to a minimum to both act as a electrical insulator but also to minimized the possible reduction of heat transfer between the soldering iron tip 102 and the heating device or elements.

As was described above with reference to electrodes 9 and 10, in the embodiments of FIGS. 8-10, the heating device 132 or heating elements 150 are preferably formed of a semi-conductive material, such as germanium, graphite, or silicon (preferably graphite), or a material containing a semi-conductive material, such as germanium, graphite, or silicon (preferably graphite). In several embodiments of the present invention, the electrical resistivity of the heating device 132 or heating elements 150 is approximately 250 micro-Ohm cm or greater, preferably approximately 750 micro-Ohm cm or greater, and more preferably approximately 1,500 micro-Ohm cm or greater. In other embodiments, the electrical resistivity of the heating device 132 or heating elements 150 is greater than approximately 3,000 micro-Ohm cm. In several embodiments, the heating device 132 or heating elements 150 preferably have a density in the range of approximately 1.0 to 2.2 g/cc, and preferably between 1.4. and 1.8 g/cc. The heating device 132 or heating elements 150, due to their resistivity as described above, may heat up to at least 500 degrees F. when electricity is supplied thereto. In the embodiment shown, power is supplied by an internal power source 108, such as one or more batteries, housed within the soldering iron body 103.

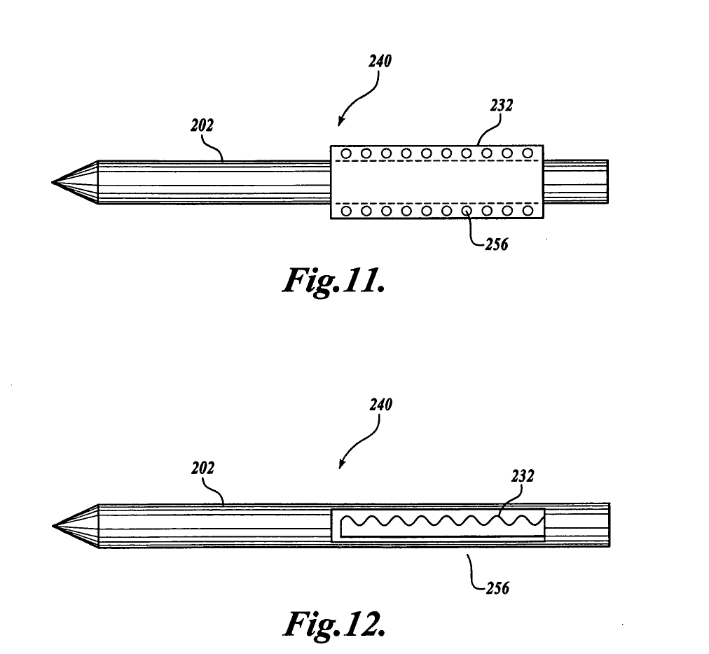

In another embodiment, the heating device may include a resistive alloy, preferably NiCr (e.g., NiCr A and NiCr C obtain suitable results with the power sources contemplated with the present invention). For example, referring to FIGS. 11 and 12, there is shown two embodiments of a tip assembly 240 comprising a heating device 232 and a soldering iron tip 202. In these embodiments, the heating device 232 includes a resistive alloy wire or element 256 disposed in heat transfer relationship with the tip 202 for heating a soldering iron tip 202.

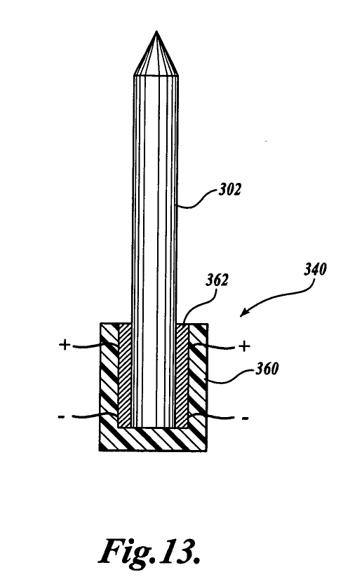

In another embodiment illustrated in FIG. 13, a tip assembly includes a heating device 340 and a soldering iron tip 302. The heating device 340 may be formed by an insulated body 360 constructed of ceramic or other thermal insulative materials and an interior liner 362 formed of a graphite foil, also known as expanded graphite. In yet another embodiment, a positive thermal coefficient (PTC) heater may be used in the place of the graphite foil.

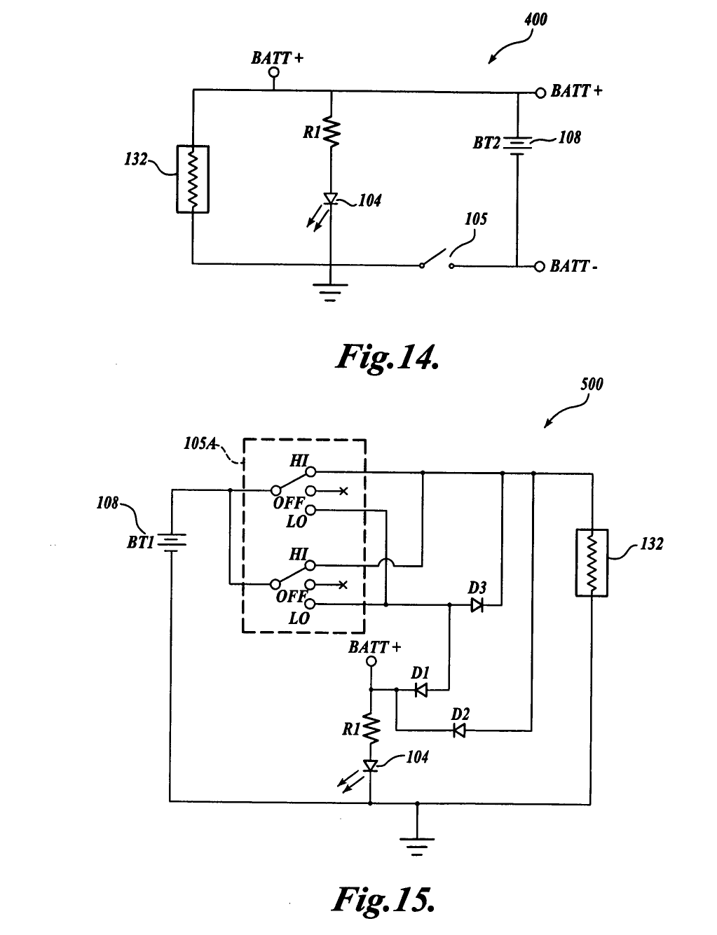

FIG. 14 illustrates an exemplary circuit 400 that may be used with the soldering iron 101 shown in FIG. 7. FIG. 14 is substantially similar to FIG. 3, except that the heating device 132 continuously provides a short circuit, and is represented schematically as a resistor. The heating device 132 is electrically connected to the positive and negative terminals of an electrical power source 108. In one embodiment, metallic contacts (not shown), preferably of beryllium copper alloy, are utilized to supply power to the heating device 132. The contacts are coupled to the body 103 and electrically connect to the remaining components of the circuit shown in FIG. 14. When assembled, the heating device 132 contacts the spaced contacts in a manner that provides electrical intercommunication. In one embodiment of the circuit illustrated in FIG. 14, the electrical power source 108 is a battery (BT2). However, a variety of electrical power sources 108 can be used, including rechargeable or non-rechargeable batteries or battery cells, or a low-voltage power source provided via a power providing device. In one embodiment, the electrical power source 108 illustrated in FIG. 14 is a battery BT1 that provides a nominal voltage of greater than 2.4 volts and an amperage of at least 700-750 milliamps, although other voltage and current values may be used.

Other embodiments may use power sources 108 having voltages in the range of five (5) to (10) volts, while others may use power sources 108 having voltages greater that 10 volts. Additionally, the power sources 108 utilized by embodiments of the present invention preferably have an instantaneous power of between 8-40 watts and an amperage of greater than 700 milliamps. In one exemplary embodiment of the present invention, the power source 8 is constructed of five (5) non-rechargeable batteries each having a voltage of approximately 1.5 volts. The batteries of the power source are connected in a conventional manner to provide a power source with approximately 7.5 volts. In embodiments of the present invention when batteries are utilized as the power source, the battery contacts are preferably of the leaf spring type for increased surface area contact and applied compression force against the batteries in an in-line arrangement to minimize losses.

As is further illustrated in FIG. 14, the circuit 400 includes the switch 105 along with an optional electric light 104 (e.g., a light-emitting diode) and a resistor R1. As is discussed hereinabove, the light 104 is positioned on the body of the soldering iron to thereby illuminate the tip 102 and any surrounding work area. The switch 105 may be placed in series with the resistor R1 and the light 4, so that the switch controls the operation of the light and the heating of the tip, and thus, may be referred to as an on/off switch. Alternatively, the switch 105 may be placed in parallel with the power source 108 and in series with the light 4 so that the switch only controls the operation of the light 4. In other embodiments, other switches may be included and appropriately wired in the circuit to allow independent operation of the light and/or soldering iron tip.

FIG. 15 illustrates another exemplary circuit 500 that is suitable for use with the exemplary embodiment of the soldering iron illustrated in FIG. 7. The circuit 500 is substantially identical to the circuit described above with reference to FIG. 4A. The circuit 500 includes a power select switch 105A that allows the user to select the power output of the soldering iron 101 between a number of power outputs, such as a high output and a low output, and an off position. To affect the different power modes controlled by the switch 105A, the circuit includes a diode D3 in the circuit path between the “Lo” nodes of the switch 105A and the heating device 132 for reducing the overall power generated by the tip 102 when the switch 105A is disposed in the “Lo” position. As a result, the power output generated by the tip 102 when the switch 105A is in the “Lo” position is less than the power output generated by the tip 102 when the switch 105A is in the “Hi” position.

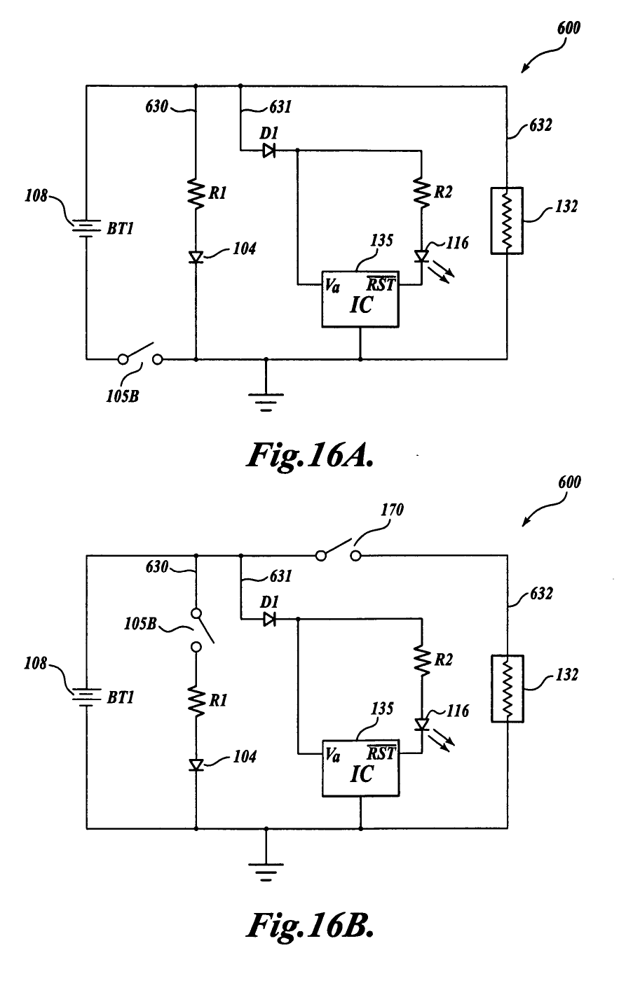

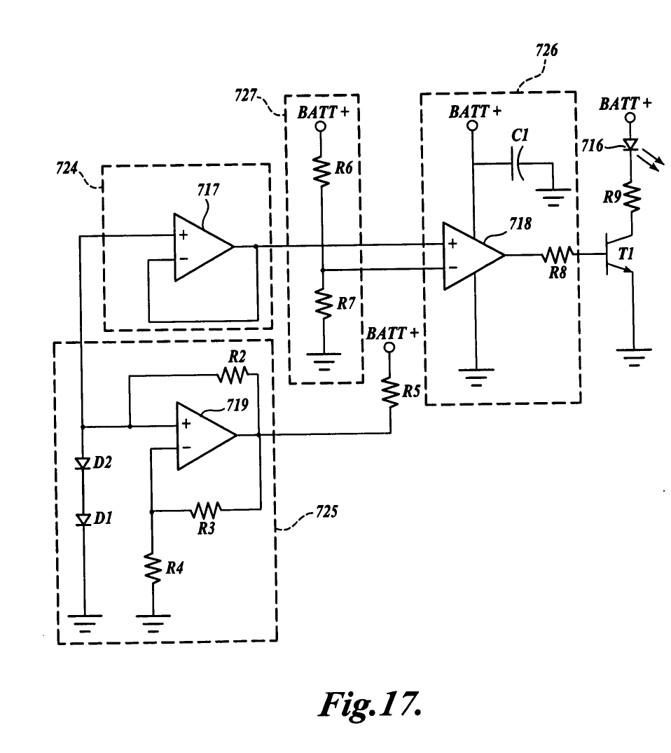

The soldering irons 101 of FIGS. 7-15 may also include other features, some of which will now be described in greater detail. For example, the soldering irons 101 may include circuitry substantially similar to that described in FIGS. 5-6B for detecting a low power condition, an operational voltage drop by the electrical power source, or current flowing through the heating device. Generally described, the circuits function to indicate by way of a light disposed on the apparatus, a low power condition of the power source or an operational drop in voltage. This is accomplished by comparing the voltage produced by the power source (across the source) during use, hereinafter referred to as the operation voltage, with a preselected reference voltage. The reference voltage may be generated by an integrated circuit, as shown in FIG. 16A, or by analog circuitry, as best shown in FIG. 17. If the operational voltage of the power source drops below the reference voltage at any time during use, then the circuit is configured to illuminate the light. In the embodiment shown in FIG. 16A, the integrated circuit compares the reference voltage to the operational voltage of the power source, and in the embodiment shown in FIG. 17, a analog comparator circuit compares the reference voltage to the operational voltage of the power source. For a more detailed description of these circuits, please see the above descriptions with reference to FIGS. 5-6B.

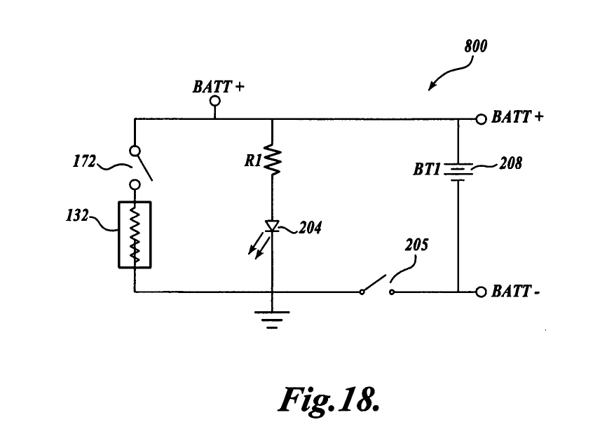

In accordance with one aspect of the present invention, the soldering iron 101 may include a power save mode that terminates or shuts off power to the heating device 132. In one embodiment, a motion switch 172, such as a mercury switch, may be electrically connected in series with the heating device 132, as shown in FIG. 18. The motion switch 172 is appropriately positioned within the soldering iron housing so that the motion switch is closed when the soldering iron tip is tilted downwards from a horizontal orientation, thus allowing electricity to flow to the heating device. By returning the soldering iron tip to a horizontal orientation, such as by resting the soldering iron on a workbench, the motion switch 172 is opened, thus prohibiting electricity from flowing to the heating device 132.

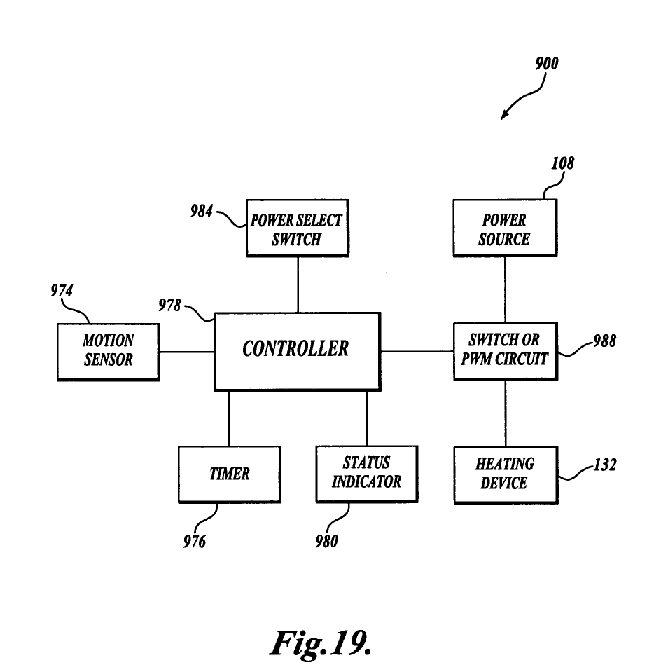

FIG. 19 illustrates a block diagram of a system 900 that may be practiced with the soldering irons of the present invention. The system 900 may be configured to provide a power save mode. In this embodiment, the system 600 includes a timer 976 functionally connected to a controller 978, which may be used in conjunction with a motion switch 974. According, when the soldering iron tip is tilted to an appropriate position, a timing signal is generated by the motion switch 974 and transmitted to a controller 978. The controller 978 receives the timing signal and starts the timer 976. The controller monitors the timer 976 until a second timing signal (i.e., the soldering iron is tilted in an appropriate position) is received from the motion switch 974, which results in resetting the timer 976. If, however, the second timing signal is not received before a preselected time period, for example, five minutes, the controller automatically shuts off power to the heating device 132 for enhancing power source life. For example, the controller 978 may output a device appropriate signal to a controllable switch 988 instructing the switch to open (i.e., prohibit electricity from flowing there through). A status indicator 980, such as a light, may be provided and suitable connected to the remaining components to indicate to the user when the soldering iron in the power save mode.

In accordance with another aspect of the present invention, the soldering irons shown in FIGS. 7-13 may include a mechanism that allows the user to select a desired power output of the soldering iron 101 at the soldering iron tip 102 between a number of power outputs, such as a high output and a low output, and an off position. In one embodiment briefly described above and shown in FIG. 15, the mechanism may be implemented in circuitry as a High/Low switch and a diode d3. Such circuitry is described in detail above with regard to FIG. 4A. However, other circuitry may be configured for allowing the user to select a desired power output. For example, instead of a throw switch and a diode, a variable resistor, such as a potentiometer may be used to generate variable power from the heating device between selected limits.

It will be appreciated that both analog and digital circuitry may be used to selectively adjust the power output of the heating device. For example, FIG. 19 illustrates a block diagram of one exemplary embodiment of a system 900 that may be practiced with the present invention. The system 900 includes a heating device 132 electrically connected to the power storage source 108 through a power select switch 984. The power select switch 984 may be any known switch that is capable of outputting a number of discrete signals. The system 900 also includes a controllable switch 988. The switch is controlled by the controller 978, which outputs control signals to the switch to either 1) closed the switch so that electricity may flow from the power source to the heating elements or 2) open the switch so that electricity is prohibited from flowing to the heating elements. The controller 978 may include a logic system for determining the operation of switch and other components hereinafter described. It will be appreciated by one skilled in the art that the logic may be implemented in a variety of configurations, including but not limited to, analog circuitry, digital circuitry, processing units, and the like. Alternatively, the controllable switch 988 may be replaced by a suitably configured pulsing circuit, such as a pulse width modulation (PWM) circuit, for modulating the power supplied to the heating elements. It will be appreciated that the pulsing circuit may be arranged by one of ordinary skill in the art, and will not be described in detail here.

In one embodiment, the controller 978 may include a processing unit, a memory, and input/output (I/O) circuitry connected in a conventional manner. The memory may include random access memory (RAM), read only memory (ROM), or any other type of digital data storage means. The I/O circuitry may include conventional buffers, drivers, relays and the like, for sending device appropriate signals to the switch or a pulse width modulation (PWM) circuit and to other circuit components.

In operation, the controller receives one of a plurality of discrete signals from the power select switch indicative of the power lever desired by the user. In response to receiving the signal, the controller outputs a device appropriate control signal or signals to the switch or PWM circuit. The signal or signals transmitted by the controller controls the operation of the switch or PWM circuit for establishing the power output desired by the user based on the output of power select switch. It will be appreciated that the controller may be programmed to continuously or selectively alter the duty cycle of the PWM circuit when establishing the desired power output of the soldering iron tip. The circuit may include other known components, such as feedback sensors, to obtain the desired power output.

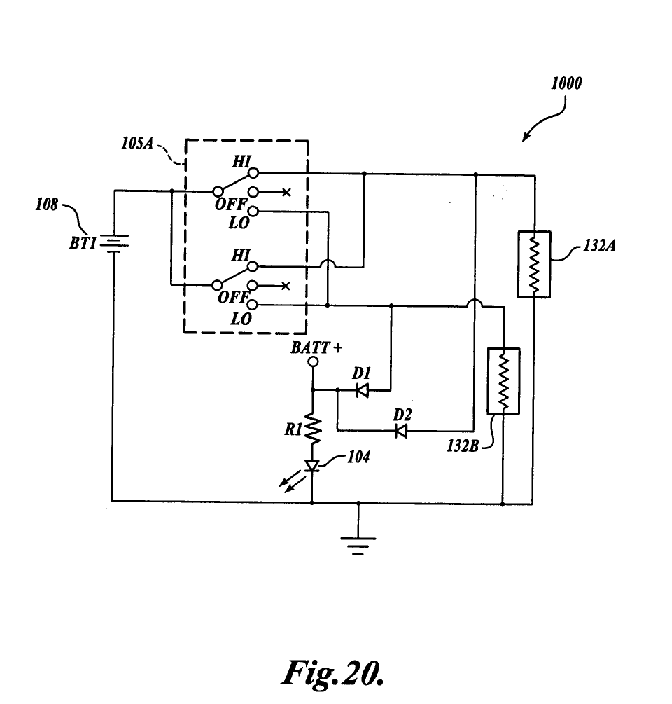

FIG. 20 illustrates another embodiment of a circuit 1000 that may be used with a soldering iron constructed in accordance with the present invention. The circuit is substantially similar to the circuit described above with reference to FIG. 15, except for the differences that will now be explained. In this embodiment, instead of using a diode to change the output power of the soldering iron tip 102 when the switch 105A is switched between the low and high positions, the soldering iron 101 includes two heating elements 132A and 132B with different resistive values. Accordingly, when the switch 105A is in the low position, electricity is routed through the heating element 132B. When the switch 105A is in the high position, electricity is routed through the heating element 132A having a larger resistive value than the heating element 132B.

While the preferred embodiment of the invention has been illustrated and described, it will be appreciated that various changes can be made therein without departing from the spirit and scope of the invention. While a cordless soldering iron has been shown and described, it will be appreciated that the soldering iron may include a power cord operably connected to the components of the soldering iron through appropriate circuitry known to those skilled in the art so that the soldering iron may be powered solely by an AC power source, such as a common household power outlet. It will be appreciated that a step down transformer and/or rectifier circuitry may be employed to operate the components of the soldering iron from power being supplied from the power outlet.

1. A soldering tool comprising:
an electrical power storage source, wherein said electrical power storage source has a low power condition;
a heating device electrically connected to the electrical power storage source for providing soldering connections; and
a voltage comparator electrically connected to the electrical power storage source and the heating device, the voltage comparator capable of detecting the low power condition of the electrical power storage source.

2. The soldering tool of claim 1, wherein the electrical power storage source achieves the low power condition when a load is placed upon the electrical power storage source by the heating device.

3. The soldering tool of claim 1, wherein said heating device comprises first and second electrodes disposed in spaced apart manner, wherein the first electrode is connected to a positive terminal and the second electrode is connected to a negative terminal of the electrical power storage source.

4. The soldering tool of claim 3, wherein the electrical power storage source achieves the low power condition when an electrical conductor is placed between the first and second electrodes when providing a soldering connection.

5. The soldering tool of claim 4, wherein the electrical conductor is solder or a workpiece.

6. The soldering tool of claim 1, wherein the low power condition is a power storage source replace or recharge condition.

7. The soldering tool of claim 6, wherein the power storage source replace or recharge condition occurs when the power storage source is substantially discharged.

8. The soldering tool of claim 1, wherein the voltage comparator includes an integrated circuit that compares a supplied voltage with an internally generated reference voltage.

9. The soldering tool of claim 1, further including a reference voltage generator, the voltage comparator being capable of receiving the reference voltage from the reference voltage generator and an operational voltage of the power storage source, comparing the received voltages, and outputting a signal indicative of the low power condition.

10. The soldering tool of claim 1, wherein the low voltage condition is determined when the operational voltage of the power storage device is lower than the reference voltage.

11. The soldering tool of claim 1, wherein the power storage source includes at least one battery.

12. The soldering tool of claim 1, wherein the power storage source has a voltage of between 5 and 10 volts.

13. The soldering tool of claim 1, wherein the power storage source produces DC current greater than about 700 milliamps.

14. The soldering tool of claim 1, further including a status indicator that generates a signal indicative of the low power condition.

15. The soldering tool of claim 16, wherein the status indicator is a light.

16. The soldering tool of claim 1, further comprising a power output switch that selectively controls the power output of the heating device.

17. An electronic apparatus, comprising:
a body;
an electrical power storage source associated with said body, said electrical power storage source including positive and negative terminals, wherein the electrical power storage source has a normal power condition and a low power condition;
a heating device associated with said body, wherein a first portion of the heating device is connected to the positive terminal and a second portion of the heating device is connected to the negative terminal so that electricity may be transmitted to the heating device; and
a status indicator electrically connected to the electrical power storage source and the heating device, the status indicator capable of generating a signal indicative of a low power condition of the electrical power storage source.

18. The apparatus of claim 17, further comprising a controllable switch, wherein the switch is activated upon a determination that a low power condition has occurred, the activation of the switch electrically disconnecting the electrical power storage source from the heating device.

19. The apparatus of claim 17, wherein the low power condition occurs when a voltage drop across the electrical power storage source is affected.

20. The apparatus of claim 17, wherein a low power condition occurs when the power storage source is substantially discharged.

21. The apparatus of claim 17, wherein the heating device includes a first electrode spaced apart from a second electrode, the first electrode being electrically connected to the positive terminal of the power storage source and the second being electrically connected to the negative terminal of the power storage source.

22. The apparatus of claim 21, wherein a low power condition occurs when a short exists across the first and second electrodes.

23. The apparatus of claim 17, wherein the apparatus is a cordless soldering iron.

24. The apparatus of claim 17, wherein the power storage source includes at least one battery.

25. The apparatus of claim 17, wherein the status indicator is a light.

26. An electronic apparatus, comprising:
an electrical power source having at least one low power condition;
a heating device electrically connected to the electrical power source;
means for detecting at least one low power condition of the electrical power source; and
means for indicating the at least one power condition.

27. The apparatus of claim 26, wherein the power source includes at least one battery.

28. The apparatus of claim 26, wherein the indicating means is a light.

29. The apparatus of claim 26, wherein the apparatus is a soldering iron.

30. An electronic apparatus powered by an electrical power source, comprising:
a heating device that receives electricity from the electrical power source; and
means for detecting at least one low power condition of the electrical power source when the heating device receives electricity from the electrical power source.

31. A soldering iron adapted to receive electricity from a power source, the soldering iron comprising:
a tip electrically connectable to the power source, the tip operable to generate heat upon application of electricity; and
a switch electrically connected between the tip and the power source, the switch having at least first and second positions that cause a first power output to be generated by the tip when the switch is in the first position and a second, higher power output to be generated by the tip when the switch is in the second position.

32. A soldering iron, comprising:
an electrical power storage source having a low power condition;
a tip electrically connected to the power source, the tip operable to generate heat upon application of electricity; and
a voltage comparator electrically connected to the electrical power storage source and the tip, the voltage comparator capable of detecting the low power condition of the electrical power storage source.

33. The soldering iron of claim 32, wherein the electrical power storage source achieves the low power condition when a load is placed upon the electrical power storage source by the heating device.

34. The soldering iron of claim 33, wherein tip comprises first and second electrodes disposed in spaced apart manner.

35. The soldering iron of claim 34, wherein the electrical power storage source achieves the low power condition when a short exists across the first and second electrodes.

36. The soldering iron of claim 35, wherein a short exist across the first and second electrodes by placing an electrical conductor in electrical communication with the first and second electrodes.

37. The soldering iron of claim 36, wherein the electrical conductor is solder or a workpiece.

38. The soldering iron of claim 32, wherein the low power condition is a power storage source replace or recharge condition.

39. The soldering iron of claim 38, wherein the power storage source replace or recharge condition occurs when the power storage source is partially or substantially discharged.

40. The soldering iron of claim 32, wherein the voltage comparator includes an integrated circuit that compares a supplied voltage with an internally generated reference voltage.

41. The soldering iron of claim 32, further including a reference voltage generator, the voltage comparator being capable of receiving the reference voltage from the reference voltage generator and an operational voltage of the power storage source, comparing the received voltages, and outputting a signal indicative of the low power condition.

42. The soldering iron of claim 32, wherein the electrical power storage source includes at least one battery.

43. A soldering iron, comprising
an electrical power storage source developing direct current (DC) and having a low power condition;
a tip electrically connected to the power source, the tip comprising first and second electrodes operable to generate heat upon application of electricity;
a voltage comparator electrically connected to the electrical power storage source and the tip, the voltage comparator capable of detecting a low power condition; and
a status indicator that generates a signal to a user in response to the voltage comparator detecting a low power condition.
